(19) United States
(12) Patent Application Publication
(10) Pub. No.: US 2007/0042334 A1
(43) Pub. Date: Feb. 22, 2007

(54) Three Dimensional Object with Lights, Flash Memory, Fiber Optics and Power USB Plug

(76) Inventor: Donald Spector, New York, NY (US)

Correspondence Address: DIEHL SERVILLA LLC, 77 BRANT AVE, SUITE 110, CLARK, NJ, 07066, US

(21) Appl. No.: 11/463,162

(22) Filed: Aug. 8, 2006

Related U.S. Application Data
(60) Provisional application No. 60/708,599, filed on Aug. 17, 2005.

(51) Int. Cl. G09B 23/28

(52) U.S. Cl. 434/262

(57) ABSTRACT

A three dimensional object is controlled by operating light sources to provide light in light conduction channels within the three dimensional object. The three dimensional object can be representative of a living thing or an inanimate object. The three dimensional object can include a processor, flash memory and a USB connector. Computers can be connected to the object via the connector to provide power to the light source and to augment the presentation.

### STATEMENT OF RELATED CASES

This patent application claims the benefit of and priority to U.S. Provisional Application Ser. No. 60/708,599, filed Aug. 17, 2005, entitled THREE DIMENSIONAL DISPLAY WITH LIGHTS, FLASH MEMORY, FIBER OPTICS AND POWER USB PLUG, which is hereby incorporated by reference.

### BACKGROUND OF THE INVENTION

Three dimensional models can be excellent tools for educational purposes. A three dimensional model allows the student to view how complex systems function within the framework of an entire structure. This allows for a degree of understanding unavailable with the typical one or two dimensional study aid.

While three dimensional models are perhaps the most effective way to learn complex systems, their use is limited due to their high cost.

By way of illustration the Museum of Natural History has a three dimensional woman display in which organs are lit up while a narrative explains basic anatomy. This system provides a good understanding of the working of the human body. This system, however, requires a coordinated recorder with an elaborate lighting system and would cost thousands of dollars to duplicate. As such, a similar model is not practical for learning in the home or classroom environment.

Accordingly, new and improved three dimensional education systems and methods are needed.

### SUMMARY OF THE INVENTION

In accordance with one aspect of the present invention, apparatus is provided that includes a three dimensional structure, one or more light conducting paths running through the structure, means for providing light to each of the one or more light conducting paths, and means for controlling the means for providing light.

The one or more light conducting paths can be fiber optic channels. They also can be channels of plastic in the structure. Any other means for conducting light can also be used.

The means for providing light can be a LED. The means for providing light can also be a laser. Any other means for providing a light can also be used.

The means for controlling the light source can be a processor and application software operable on the processor to control the operation of the means for providing light.

It can also be a processor, a USB connector and a jump drive connected to the USB connector, the jump drive including application software that controls the operation of the means for providing light.

It can also be a USB connector and a computer connected to the USB connector, the computer including application software that controls the operation of the means for providing light.

A computer or other electronic device can provide power to the means for providing light via the USB connector.

The computer connected to the structure device can augment the presentation relating to the structure by playing an audio track related to the three dimensional structure and by displaying a video sequence related to the three dimensional structure.

The three dimensional structure can represent a living object or an inanimate object and the means for providing light are controlled to demonstrate how the object functions.

The structure can also be connected to a server on the Internet via a connected computer or by direct means. The server can be used to control the means for providing light and for providing additional information to augment the description of the three dimensional structure.

In accordance with another aspect of the present invention, apparatus is provided that includes a three dimensional structure having one or more light conducting paths running through the structure, a light source for each of the one or more light paths and a processor that can control the light source in a manner to demonstrate how the three dimensional structure operates.

The processor can be located inside the apparatus, for example in a base that holds the three dimensional structure.

A USB connector can also be provided.

The processor can be a computer connected to the structure via the USB connector.

A server can also be connected to the computer, preferably via the Internet, so that the server provides additional information relating to the three dimensional structure.

In accordance with further aspects of the present invention, corresponding methods of illuminating and illustrating a three dimensional object are provided.

### DESCRIPTION OF THE DRAWINGS

FIG. 1 illustrates a three dimensional object with associated electronics in accordance with one aspect of the present invention.

FIG. 2 illustrates a three dimensional object connected to a server on the Internet in accordance with a further aspect of the present invention.

FIG. 3 illustrates a jump drive device inserted into a three dimensional object in accordance with another aspect of the present invention.

FIG. 4 illustrates a heart with light conducting paths on a stand in accordance with a further aspect of the present invention.

### DESCRIPTION OF A PREFERRED EMBODIMENT

This patent relates to a product that is three dimensional and has verbal and coinciding lights, it is particularly suitable to educational purposes though it might be used for other purposes. It is envisioned that this product will have an enormous cost advantage over other products that deliver a similar result based on totally different systems. In accordance with one aspect of the present invention, there is a base that has multiple lights and a flash memory component. There is no speaker system, no recorder. The top part would consist of injection molded plastic in two parts, some of which would be painted or colored plastic, to resemble the various organs or other living objects.

When the two plastic halves are sonically welded (or glued) they would create canals to the various organs. These canals would have fiber optic strands, or plastic with fiber optic properties, such that they can convey light from a base station to the various parts.

The flash memory would interact with the computer as a plug and play to give a narrative and also contain “cues” that would activate the various lights on the base station, which in turn would light up the various organs on cue.

Since, in accordance with this aspect of the present invention, this educational model would contain no sound, or electricity (being powered by the power USB port) it would be inexpensive to produce, but duplicate a display that would cost many times what this invention would cost.

This device could also be made with wires and lights instead of plastic strands with fiber optic properties and could contain batteries in the base so that it could use a non-power USB port if necessary.

The product in accordance with this aspect of the present invention could also be used to create a 3D version of a city or a theme park such as Disneyworld. When plugged in the voices of the characters could bring the park to life as the lights created everything from lighting up the various parts of the park as they are being discussed to fireworks with sound.

In accordance with other aspects of the present invention, the products could be built in any scale so that they could be used as full size models in schools and colleges and demonstrate various systems of anatomy or mechanical items being taught.

Various aspects of the present invention are further described with respect to the figures.

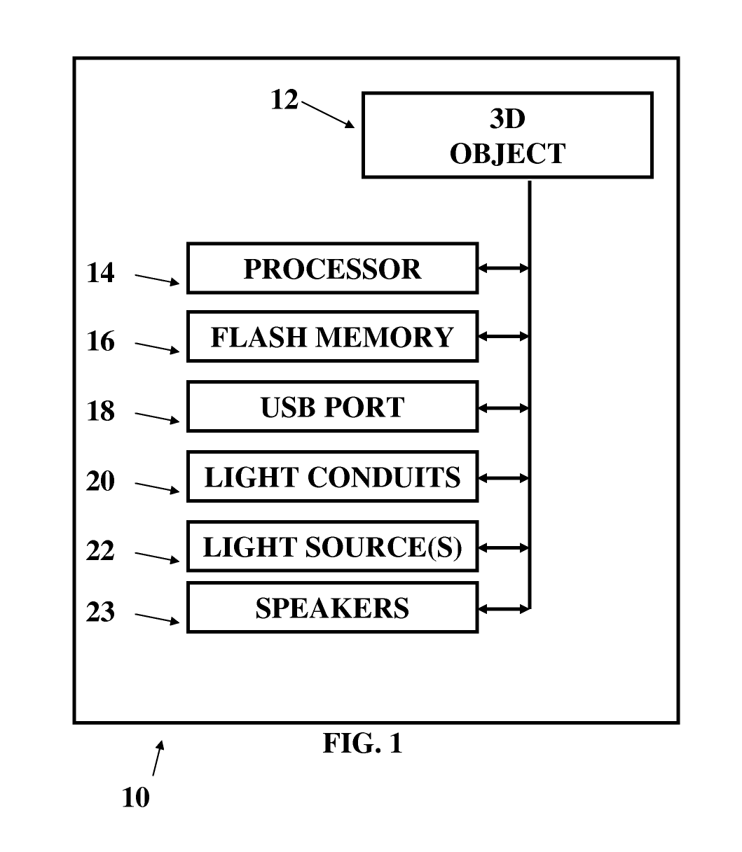

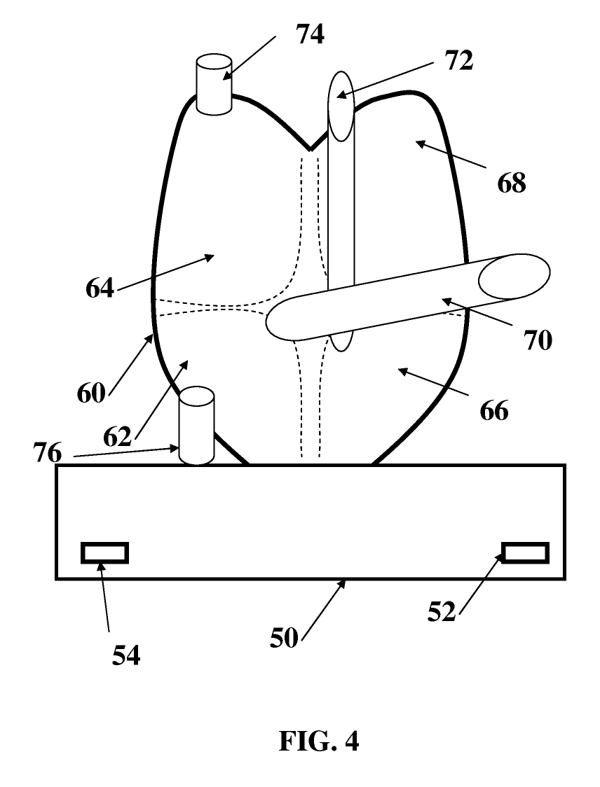

FIG. 1 illustrates a three dimensional object 10 with associated electronics in accordance with one aspect of the present invention. The object includes a three dimensional replica 12 of an object whose functionality is to be illustrated. The replica 12 is preferably made from plastic, but any other convenient translucent material can be used. The replica 12 can be mounted in a base as illustrated in FIG. 4.

The object 10 in one embodiment of the present invention includes a processor 14, a flash memory 16, a connector 18, one or more light conducting paths or conduits 20 and one or more light sources 22 to illuminate the light conducting paths 20. All of these components can be provided in the object 10, or in alternate embodiments of the present invention, a subset of the components can be provided.

The one or more light conducting paths can be fiber optic channels embedded in the structure 12. They are embedded in such a way to illustrate the operation of the object represented by the structure 14. In another embodiment, the one or more light conducting paths can be channels of plastic in the structure 12.

A light source is preferably provided for each of the light conducting paths in the structure 12. The light source can be a LED or a laser or any other suitable source of light.

In accordance with one aspect of the present invention, an application software program is resident on the flash memory 16. The processor 14 reads the program from the flash memory 16 and controls the light sources 22. The light sources 22 cause the light conducting paths 20 to illuminate in a sequence such that the operation or functioning of the object 10 is illustrated to a viewer.

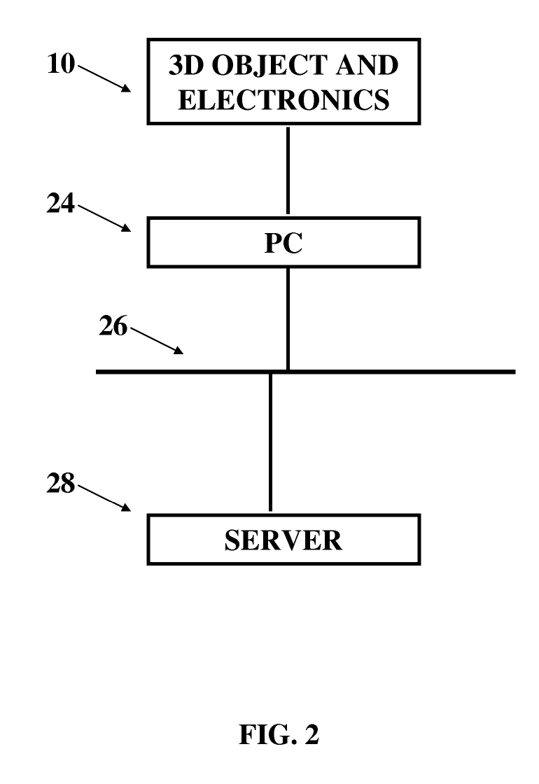

FIG. 2 illustrates a three dimensional object connected to a server on the Internet in accordance with a further aspect of the present invention. A personal computer 24 or other computing device is connected to the object 10 through the connector 20. The connector 20 is preferably a USB connector. The computer 24 can provide power to the object 10 through the USB connector 20.

The operation of the light sources 22 to illuminate the light conducting paths 20 can be controlled by the computer 24 through the connector 20. In this case, the processor 14 and the flash memory need not be located in the object 10, but can be provided as part of the computer 24.

The computer 24 can also augment the description of the object by providing an audio track and visual display further describing the object 10.

Referring to FIG. 2, a server 28 on the Internet 26 can be connected to the object 10. The server 28 can also control the operation of the light sources 22 and the light conducting path 20. The server 28 can also be accessed to supply the additional information to augment the description of the object 10.

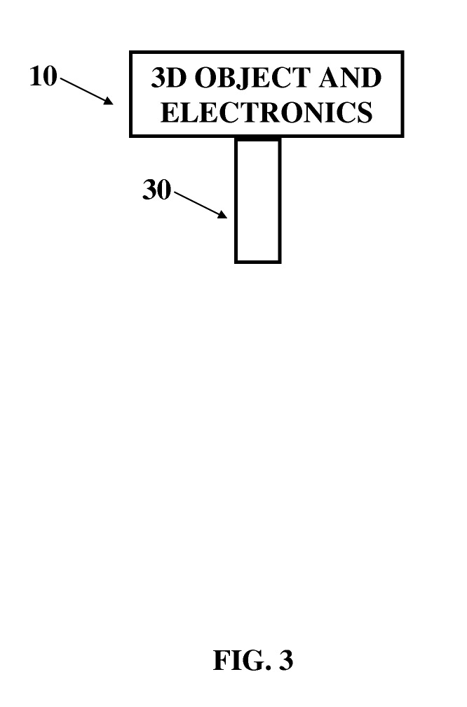

FIG. 3 illustrates a jump drive device 30 inserted into a three dimensional object in accordance with another aspect of the present invention. A processor 14 can read an application from the jump drive 30 to provide control of the light sources 22 to light the light conducting paths 20.

FIG. 4 is one example of a three dimensional object that can be provided in accordance with various aspects of the present invention. A base 50 has connectors 52 and 54. The connector 52 is preferably a USB connector.

A three dimensional version of a heart 60 is mounted in the base 50. The heart 60 has four areas 62, 64, 66, and 68 corresponding to the right ventricle, the right atrium, the left ventricle and the left atrium, respectively. Major blood vessels in and out of the heart are also represented, including the pulmonary trunk 70, the aorta 72, the superior vena cava 74 and the inferior vena cava 76. Each of these blood vessels is represented by a light path which is lit by a light source in sequence to indicate the functioning of a heart. Additionally, the cavities 62 to 68 are provided with light paths surrounding the cavity to indicate when the cavity fills with blood. All of the light paths and the associated light sources are controlled in unison, either by an on-board processor or by a connected computer or by a connected flash drive, to light up in sequence to indicate the operation of the heart.

Any other three dimensional object wherein the operation or functioning of the object can be illustrated with lights can be held in the base 50. The object can be a living organ or thing, but can also be an inanimate object.

The object 10 can also include one or more speakers 23 to provide descriptions of the object 10. The audio track to be broadcast by the speakers 23 can be stored on the flash memory 16 and sent to the speakers 23 by the processor 14. Alternatively, the audio track can be stored on a jump drive 30 and sent to the speakers 23 by the processor 14. The audio track could also be provided by the computer 24 or by a server 28 connected to the computer 24 via the Internet.

The object 10 can be connected to a server 25 as illustrated in FIG.2. The server 28, as previously mentioned, can provide video and audio contact related to the object 10 to be presented in the computer 24 via the Internet 26. Further, the server 28 can be connected to a related radio channel and can provide the audio from the radio channel to the object 10 to be broadcast by the speakers 23 in the object 10. The audio, from either the radio channel or the server 28, can be information relating to the object 10 and can also be advertising. The advertising can relate to the object 10 or to an entity related to the object 10. The audio from the server 25 or the radio channel can be provided to the object 10 in a real time streaming mode. Alternatively, it can be downloaded into the flash memory 16 to be played by the speaker 33 under control of the processor 14 when the object 10 is turned on. The server 28 can be a website.

By way of example, if the object 10 is a souvenir purchased at the Vatican, audio from the Vatican Network can be supplied to the object to be broadcast by the object 10. The audio can include the Vatican's messages and advertising.

As another example, the object 10 could be a theme park from Disney. Disney's radio channel can supply audio to the object 10 via a server 28 to supply related messages and advertising. The server 28 can be Disney's website.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. Apparatus, comprising:
a three dimensional structure;
one or more light conducting paths running through the structure;
means for providing light to each of the one or more light conducting paths; and
means for controlling the means for providing light.

2. The claim of claim 1, wherein the one or more light conducting paths are fiber optic channels.

3. The claim of claim 1, wherein the one or more light conducting paths are channels of plastic in the structure.

4. The claim of claim 1, wherein the means for providing light is a LED.

5. The claim of claim 1, wherein the means for providing light is a laser.

6. The claim of claim 1, wherein the means for controlling is a processor and application software operable on the processor to control the operation of the means for providing light.

7. The claim of claim 1, wherein the means for controlling is a processor, a USB connector and a jump drive connected to the USB connector, the jump drive including application software that controls the operation of the means for providing light.

8. The claim of claim 1, wherein the means for controlling is a USB connector and a computer connected to the USB connector, the computer including application software that controls the operation of the means for providing light.

9. The claim of claim 8, wherein the computer provides power to the means for providing light via the USB connector.

10. The claim of claim 8, wherein the computer plays an audio track related to the three dimensional structure.

11. The claim of claim 8, wherein the computer displays a video sequence related to the three dimensional structure.

12. The claim of claim 10, wherein the computer displays a video sequence related to the three dimensional structure.

13. The claim of claim 1, wherein the three dimensional structure represents a living object and the means for providing light are controlled to demonstrate how the living object functions.

14. The claim of claim 1, wherein the three dimensional structure represents an inanimate object and the means for providing light are controlled to demonstrate how the inanimate object functions.

15. The claim of claim 8, comprising a server connected to the computer.

16. The claim of claim 15, wherein the server is connected to the computer via an Internet connection.

17. The claim of claim 16, wherein the server provides control of the means for providing light.

18. Apparatus, comprising:
a three dimensional structure having one or more light conducting paths running through the structure;
a light source for each of the one or more light paths; and
a processor that can control the light source in a manner to demonstrate how the three dimensional structure operates.

19. The claim of claim 16, comprising a USB connector.

20. The claim of claim 19, wherein the processor is a computer connected via the USB connector.

21. The claim of claim 20, comprising a server connected to the computer, wherein the server provides additional information relating to the three dimensional structure.

22. The claim of claim 20, comprising a server connected to the computer, the server providing an audio stream to the three dimensional structure that can play the audio stream on a speaker.

23. A system, comprising:
a three dimensional structure have a speaker;
a web site connected to the three dimensional structure that provides an audio stream to the three dimensional structure,
wherein the three dimensional structure broadcasts the audio stream on the speaker.

24. The system of claim 23, the three dimensional structure having a memory to store the audio stream.

25. The system of claim 23, wherein the server provides an audio stream to the three dimensional structure to be broadcast in real time.

26. The system of claim 23, wherein the audio stream contains advertising relating to the three dimensional structure or to the website.
